(19) United States
(12) Patent Application Publication
(10) Pub. No.: US 2018/0276623 A1
(43) Pub. Date: Sep. 27, 2018

(54) METHOD AND SYSTEM FOR MANAGING DATA RELATING TO A BEARING

(71) Applicant: SCHAEFFLER TECHNOLOGIES AG & CO. KG, Herzogenaurach (DE)

(72) Inventors: Michael PAUSCH, Dittelbrunn (DE); Thomas BUCHNER, Unterpleichfeld (DE)

(73) Assignee: SCHAEFFLER TECHNOLOGIES AG & CO. KG, Herzogenaurach (DE)

(21) Appl. No.: 15/764,698

(22) PCT Filed: Sep. 28, 2016
(86) PCT No.: PCT/DE2016/200453

§ 371 Date: Mar. 29, 2018

(30) Foreign Application Priority Data
Oct. 1, 2015 (DE) 10 2015 219 030.7

(51) Int. Cl. G06Q 10/00; F16C 41/00; G06K 19/06

(52) U.S. Cl. CPC G06Q 10/20; G06K 19/06037; F16C 41/008

(57) ABSTRACT

A computer-implemented method for managing data relating to a bearing, wherein the bearing comprises multiple bearing components. The bearing is produced from the multiple bearing components in a production method. The computer-implemented method includes detecting the data relating to the multiple bearing components and/or relating to the production method, saving the data in a production database, generating a machine-readable identifier for clear identification of the bearing, wherein the machine-readable identifier is associated with the data and is arranged on the bearing. The method also includes copying the data relaxant to the use of the bearing into a customer database, reading the identifier on the bearing, activating access to the customer database for the data, retrieving some or all of the data relevant to the use of the bearing from the customer database, and processing the retrieved data.

### CROSS-REFERENCE TO RELATED APPLICATIONS

This application is the U.S. National Phase of PCT/DE2016/200453 filed Sep. 28, 2016, which claims priority to DE 102015219030.7 filed Oct. 1, 2015, the entire disclosures of which are incorporated by reference herein.

### TECHNICAL FIELD

The present disclosure relates to a system for information technology integrated management of data relating to a bearing, comprising a server system and a client system. The disclosure further relates to a computer implemented method for managing data relating to a bearing and a computer program product for executing the computer-implemented method.

### BACKGROUND

With bearings, in particular roller bearings, bar codes or data matric codes are typically used for serialization purposes or for direct attachment of bearing-specific data to the product. Labels with bearing-specific data are also normally included in the packaging. These data can only be found in general by the client on said label. When the written information is lost, important information regarding tolerances, for example, necessary for installation, are lost. Data relating to the service life of a bearing is also generally documented in a written note, which is subsequently scanned. The digitalized data, however, are normally in a file format that is not suitable for data processing. Furthermore, assignment of the bearing-specific data of the manufacturer must also be carried out manually. New bearing-specific manufacturer information, obtained, for example, from long-term tests by the manufacturer, must likewise be transmitted, assigned, and compiled manually.

### SUMMARY

One object of the disclosure is to enable management of the data relating to a bearing, from the production phase at the manufacturer end to use by the client, over the entire lifetime of the bearing, in a digital format. A specific bearing should be clearly assignable on the basis of its bearing-specific data, and the data should be electronically available, searchable, editable, supplementable, and at least exchangeable between the manufacturer and the client, or other third parties. In particular, it is an object of the disclosure to prevent breakdown of the communication and the data formats for the bearing-specific data.

These technical problems are solved according to the disclosure by the technological features of the independent claims in the form of a method, implemented at least in part by a computer, a computer program product, a server system, a client system, and a system comprising a client and server system.

Accordingly, the method according to the disclosure for managing data relating to a bearing, wherein the bearing comprises numerous bearing components, and wherein the bearing is produced in a production process from the numerous bearing components, comprises recording the data relating to the numerous bearing components and/or relating to the production process.

In one embodiment, the bearing comprises the bearing components, an inner ring and an outer ring, and can be a roller bearing or a sliding bearing. There are component-specific data for the bearing components. Other data are acquired during the production process, such as measurement data. Thus, the inner ring and outer ring, for example, are paired, whereby each bearing has specific tolerances. These tolerance data are relevant to the bearing installation, for example. In particular with spindle bearings for high precision machines tools, the tolerance data are extremely important.

Furthermore, the method according to the disclosure comprises storing the data in a production data base, and generating a machine-readable ID for positive identification of the bearing. The machine-readable ID can be assigned to the data, and disposed on the bearing. By way of example, the machine-readable ID can be disposed on the outer ring. This has the advantage that the machine-readable ID can be a two-dimensional bar code, for example, such as a data matric code, which can be formed on the side of the outer ring with a laser or etching process. An RFID chip is also conceivable, which is disposed or embedded in a bearing component of the bearing.

Furthermore, the method according to the disclosure comprises copying data regarding bearing usage from the data in a client data base. In other words, the method according to the disclosure comprises providing bearing usage data in a separate data base, and thus withholding confidential production data that would allow conclusions to be drawn regarding the production process.

In an alternative embodiment, the production data base and the client data base are the same data base, in which the usage data are accessible. With regard to data base technology, this can take place, for example, by making it read-accessible for certain data base users. The important thing is that it is ensured that confidential data, if present, as such can also be kept confidential.

Furthermore, the method according to the disclosure comprises reading the machine-readable ID on the bearing and unlocking access to the client data base for the bearing usage data assigned to the machine-readable ID. The machine-readable ID can be read by a client system, e.g. a transportable smartphone with a camera. The client system can be used by clients that have not yet received bearing usage data.

In an alternative embodiment, the method according to the disclosure can comprise storing the machine-readable ID in an authentication data base for checking the authenticity, and thus a preliminary checking of the authenticity of the bearing can take place via querying the authentication data base before access to the client data base has been unlocked. If the machine-readable ID is authenticated, access to the client data base is unlocked. This has the advantage that counterfeit bearings can be detected. The authentication can take place, for example, via trustworthy third party developers. The authentication can also be implemented via a system belonging to the manufacture.

Furthermore, the method according to the disclosure comprises retrieving some or all of the bearing usage data from the client data base, and processing said data for a bearing-specific activity, wherein the retrieved data can be used for the bearing-specific activity. The client can thus retrieve only specific bearing usage data, e.g. a measurement value needed by the client for calculating an installation setting of the bearing in the machine.

When all of the data are retrieved, it is possible to store the data in a client data base in one embodiment of the method. It is also possible to store data that has only been partially retrieved or processed data in the client data base.

The bearing-specific activity is at least one of the following activities, by way of example:
Installation of the bearing in a machine
Use of the data in a computer-implemented bearing management system, in particular for ordering new bearings or replacement parts for the bearing,
Commissioning maintenance
Controlling or adjusting the machine with the bearing to improve production, wherein the machine is used in the production line, or
Technological monitoring of the bearing operation.

In one embodiment, the bearing is used for a bearing-specific activity, e.g. the bearing can be monitored (condition monitoring), and the method also comprises the recording of operating data relating to the bearing during this bearing-specific activity. The operating data, such as lubrication composition, can be further processed, e.g. in order to calculate the remaining service life of the bearing. The processed data can then be stored in the client data base. The recorded operating data can also be stored directly in the client data base. It is conceivable to store recorded and processed operating data in the client data base in each step of the method. It is thus possible to obtain a continuous documentation of the operation of the bearing, thus enabling a subsequent evaluation of the bearing history.

In one embodiment, the method also comprises transmitting and storing the operating data and/or the processed operating data in a data base. This data base can be the client data base. Other data bases are also conceivable, which are connected, for example, to systems for a special evaluation of the operating data. It may be the case, that measurement values regarding the lubricant composition of the bearing can be evaluated better by the lubricant manufacturer than the bearing manufacturer.

The data or operating data can comprise one or more of the following types of data:
Measurement data regarding bearing components or bearings (bore diameters, outer diameters, width, pressure angle, protrusions, impact values, load ratings, rolling frequencies, weights, material specifications)
Production data on the bearing (production date, serial number, name)
Tolerance data
Calculation data
Sales data on the bearing
Estimate data for installation.

Another aspect of the present disclosure is a computer program product, which, when loaded into a memory of a data processing system, and executed by at least one processor of the data processing system, executes the steps of the computer-implemented method.

Further aspects of the present disclosure are a server system for processing data relating to a bearing, a client system for processing bearing usage data relating to the bearing, and a system for managing these data, comprising a client system and a server system, as described above and in the following. The system for managing data relating to a bearing can thus comprise the properties of a client-server architecture and/or computer-to-computer connections, e.g. a peer-to-peer architecture.

Further advantages, features and details of the disclosure can be derived from the exemplary embodiments described below, and from the drawings.

### BRIEF DESCRIPTION OF THE DRAWINGS

Exemplary embodiments of the disclosure shall be described below, based on the drawings. The figures show drawings, not drawn to scale. Therein:

FIG. 1 shows an overview of an information technology integrated data management relating to a bearing,

FIG. 2 shows a flow chart for a computer-implemented method for managing data relating to a bearing, and

FIG. 3 shows a block diagram of a system for managing data relating to a bearing.

### DETAILED DESCRIPTION OF THE DRAWINGS

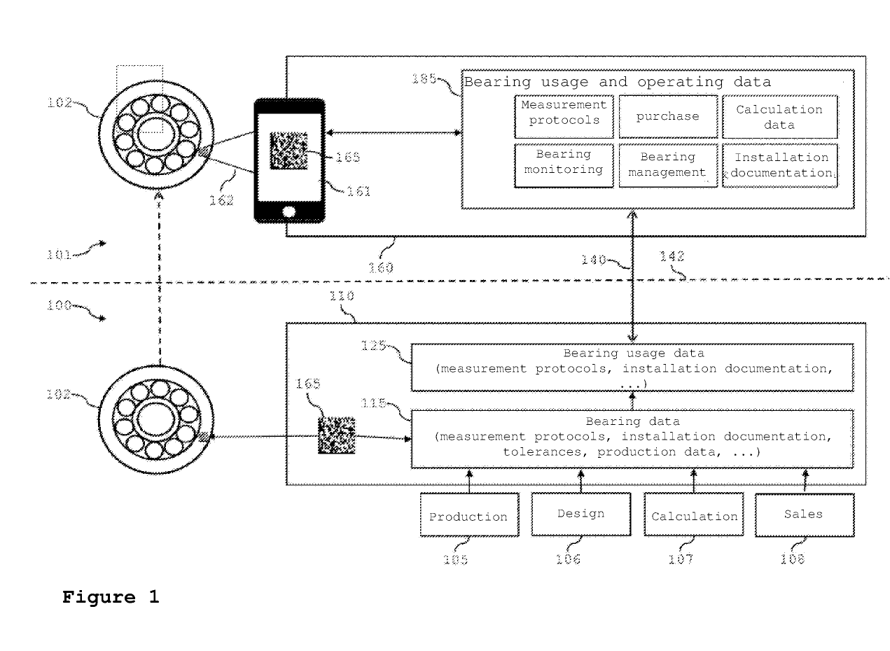

FIG. 1 shows an overview of an information technology integrated management of data 105, 106, 107, 108, 115, 125, 185 relating to a bearing 102. The overview is divided according to the principles thereof into a region 100, which relates to the management and processing of the data 105, 106, 107, 108, 115, 125 at the production end, and a region 101, which relates to the management and processing of the data 185 at the client end, where the bearing is used. The bearing 102 is the same bearing in both regions 100, 101, first in production, and later during operation, e.g. when used in a spindle bearing. The regions 100, 101 are separated in FIG. 1 by the broken line 142. The regions 100, 101 can be separated geographically, wherein a server system 110 in the region 100 is connected to a client system 160 in the region 101 via a data connection 140 for data communication.

FIG. 1 also shows various data 105, 106, 107, 108, which are recorded as bearing data 115 in the server system 110. Furthermore, a data matrix code 165 is stored in the server system 110, to which the bearing data 115 can be explicitly assigned, i.e. the bearing data 115 can be explicitly assigned to the data matrix code 165. The data matrix code 165 is likewise attached to the bearing 102. The bearing 102 can thus be explicitly assigned to the bearing data 115, and vice versa. Furthermore, the server system 110 comprises bearing usage data 125, normally representing a subset of the bearing data 115.

The client system 160 is shown in FIG. 1 in the region 100. Such a client system can be a portable smartphone 1601, or a tablet, for example. It can also be composed of numerous individual devices, such as a scanner, which sends scanned data to a laptop. The client system 160 is configured to scan 162 the data matrix code 165 on the bearing 102 and to evaluate it accordingly. The client system 160 can thus store data 185 relating to the operation of the bearing in conjunction with the associated data matrix code 165 in the client system 160. The client system 160 can also retrieve bearing usage data 125 assigned to the data matrix code 165. The client system 160 can also process the data 185, thus retrieved data 125 as well, and store the results. Alternatively or additionally, the client system 160 can send the data 185, or the computing results, back to the server system 110 via the data connection 140. The transmitted data can be stored together with the bearing usage data 125.

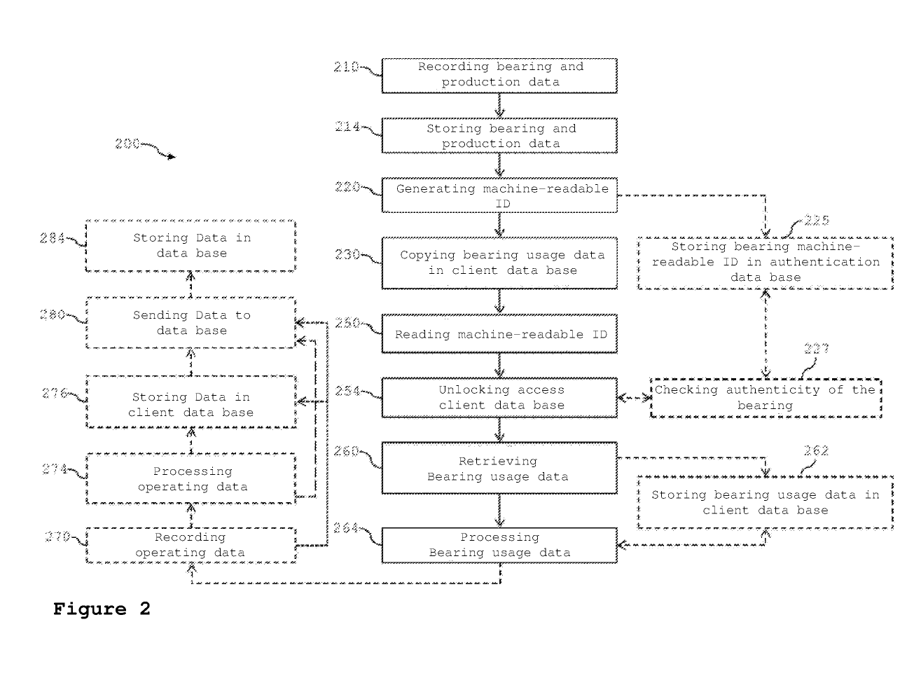

FIG. 2 shows a flow chart for a computer-implemented method 200 for managing data relating to a bearing, wherein the bearing comprises numerous bearing components, and wherein the bearing is produced from the numerous bearing components in a production process. The method comprises: recording 210 the data relating to the numerous bearing components and/or relating to the production process, storing 214 the data in a production data base, generating 220 a machine-readable ID for positive identification of the bearing, wherein the machine-readable ID can be assigned to the data, and wherein the machine-readable ID is disposed on the bearing. The method also comprises copying 230 bearing usage data from the data in a client data base, reading 250 the machine-readable ID on the bearing, unlocking 254 access to the client data base, for the bearing use data assigned to the machine-readable ID, retrieving 260 some or all of the bearing usage data from the client data base, and processing 264 the retrieved data for a bearing-specific activity, wherein the retrieved data can be used for the bearing-specific activity.

The method 200 further comprises optional method steps, which are indicated in FIG. 2 with a broken line. The method thus comprises storing 262 the retrieved data and/or processed data in a client data base.

The method furthermore comprises, optionally, when the bearing is used for the bearing-specific activity, the recording 270 of operating data relating to the bearing during the bearing-specific activity, and the processing 274 of the operating data. The processed operating data can subsequently be stored in the client data base 276, or alternatively, sent 280 directly to another data base. Another possibility is to store 276 the recorded operating data in the client data base without processing thereof, or to send 280 the unprocessed data to another data base 280. The transmitted data are subsequently stored 284 in the other data base. The other data base can be the client data base, for example, to further evaluate the recorded and/or processed operating data on a server system. The other data base can also be part of another server system, used only for evaluating the transmitted data.

The method 200 also comprises, optionally, the storage 225 of the machine-readable ID in an authentication data base for checking the authenticity of the machine-readable ID (and thus the bearing), checking 227 the authenticity by querying the authentication data base, and if the machine-readable ID is authenticated, unlocking 254 access to the client data base. The storage step 225 and checking step 227 can take place at different times. In particular, the storage 225 of the machine-readable ID can take place on a trustworthy server of a third party developer, and the checking 227 of the authenticity of the machine-readable ID (and thus the bearing) can be carried out directly with this server by the third party developer. In other words, the third party developer, as a trustworthy entity, can thus execute this optional step of the computer-implemented method between a manufacturer and a client.

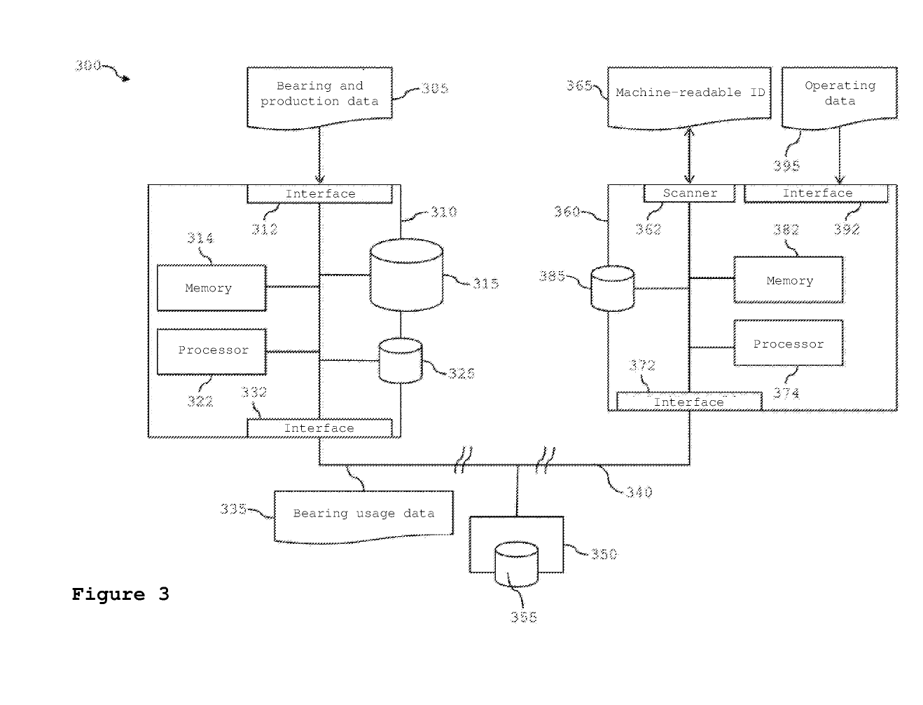

FIG. 3 shows a block diagram for a system 300 for managing data 305, 335, 395 relating to a bearing. The system 300 comprises a server system 310 and a client system 360, wherein the server system 210 and the client system 260 are connected via a data connection 340 for data communication. The server system 310 and the client system 360 can be placed at geographically different locations. It is also possible, in particular, for numerous client systems to communicate and exchange data with the server system 310. A client system 360 can also contact numerous server systems 310. This may be useful, for example, in evaluating measurement data from the bearing operation, one server system for evaluating lubricant measurement values and another server system for evaluating slippage measurement values in a roller bearing.

The server system 310 for processing data 305 relating to the bearing, wherein the bearing comprises numerous bearing components and wherein the bearing is produced in a production process from numerous bearing components, comprises a first interface component 312, which is configured to record data 305 relating to the numerous bearing components and/or relating to the production process, a data storage component 315, configured to store data in a production data base 315, and at least one processor component 322, configured for the following processing steps: generation of a machine-readable ID 365 for the positive identification of the bearing, wherein the machine-readable ID 365 can be assigned to the data 305, and wherein the machine-readable ID 365 is disposed on the bearing, identification of bearing usage data 335 from the data 305, and copying the bearing usage data in a client data base 325.

Furthermore, the server system 310 can comprise a second interface component 332, as shown in FIG. 3, which is configured to send the machine-readable ID 365 to an authentication system 350 that has an authentication data base 355.

The client system 360 for processing bearing usage data 335 relating to the bearing comprises a reader component 362, configured to read a machine-readable ID 365 on the bearing, an interface component 372, configured for transmitting an access query for access to a client data base 2325, wherein the access query comprises the machine-readable ID 365, and at least one processor component 374, configured for the following processing steps: retrieval of some or all of the bearing usage data 335 from the client data base 235, and processing the retrieved data for a bearing-specific activity, wherein the retrieved data can be used for the bearing-specific activity.

Furthermore, the client system 360, as shown in FIG. 3, can comprise a data storage component 382, which is configured for storing the retrieved data and/or processing data in a client data base 385.

Furthermore, the interface component 372 of the client system 360, as shown in FIG. 3, can also be configured such that the access query is sent directly to the server system 310 that has the client data base 325. In this case, the authentication system 350 does not communicate with the client system 360. Alternatively, as also illustrated in FIG. 3, the access query can be sent to the authentication system 350 that has the authentication data base 355 for checking the authenticity of the machine-readable ID (and thus the bearing).

Furthermore, the client system 360, as shown in FIG. 3, can comprise a further interface component 392, which is configured for recording the operating data 395 relating to the bearing during the bearing-specific activity, and the at least one processor component 374 can also be configured for processing the operating data 395.

The data storage component 382 of the client system 360, as shown in FIG. 3, can also be configured for storing the operating data 395 and/or processing operating data in the client data base 385.

The interface component 372 of the client system 360, as is shown in FIG. 3, can also be configured for sending the operating data and/or the processed operating data to a data base, in particular the client data base 325.

The data bases 315, 325, 355, 385 are shown in FIG. 3 on the system boundaries of the respective systems 310, 350, 360. This is intended to demonstrate that the data bases 315, 325, 355, 385 do not necessarily have to be integrated in the systems, or implemented as parts of the system. It is also possible for the data bases to be implemented in a physically different system, e.g. as a so-called cloud memory. This has the advantage that the stored data can be easily safeguarded, e.g. via data mirroring or automatic data backups. It is also possible therewith for numerous systems to access the data. Likewise, loss or damage to the client system is less critical when used in the field, because the data are not, or not entirely, lost thereby.

### LIST OF REFERENCE SYMBOLS

100, 101, 142 Regions for managing and processing data

102 bearing

105, 106, 107, 108, 115, 125, 185 data

110 server system

140 data connection

160 client system

161 smartphone

162 scanning

165 data matrix code

200 computer-implemented method for managing data relating to a bearing

210, 214, 220, 225, 227, 230 250, 254, 260, 262, 264, 270 274, 276, 280, 284 Method steps for the computer-implemented method 200

300 system for managing data relating to a bearing

305, 335, 395 data

310 server system

312, 314, 322, 332 components of the server system 310

315, 325, 355, 385 data bases

340 data connection

350 authentication system

360 client system

365 machine-readable ID

362, 372, 374, 382, 392 components of the client system 360

1. A computer-implemented method for managing data relating to a bearing, wherein the bearing includes numerous bearing components and is produced from the numerous bearing components in a production process, the computer-implemented method comprising the following steps:
recording the data relating to the numerous bearing components and the production process;
storing the data in a production data base;
generating a machine-readable ID for a positive identification of the bearing, wherein the machine-readable ID is assigned to the data, and wherein the machine-readable ID is disposed on the bearing;
copying bearing usage data from the data in a client data base;
reading the machine-readable ID on the bearing;
unlocking access to the client data base for the bearing usage data assigned to the machine-readable ID;
retrieving some or all of the bearing usage data from the client data base; and
processing the retrieved data for a bearing-specific activity, wherein the retrieved data is used for the bearing-specific activity.

2. The computer-implemented method according to claim 1, wherein the method further comprises storing the retrieved data or processed data in a client data base.

3. The computer-implemented method according to claim 1, wherein the bearing is used for the bearing-specific activity, the method further comprising:
recording operating data relating to the bearing during the bearing-specific activity,
processing the operating data, and
storing the operating data and processed operating data in the client data base.

4. The computer-implemented method according to claim 3, wherein the method further comprises:
sending the operating data and processed operating data to the client data base, and
storing the transmitted data to the client data base.

5. The computer-implemented method according to claim 1, further comprising:
storing the machine-readable ID in an authentication data base for checking the authenticity of the bearing,
checking the authenticity by means of querying the authentication data base, and when the machine-readable ID is authentic,
continuation of the unlocking access to the client data base.

6. (canceled)

7. A server system for processing data relating to a bearing, wherein the bearing includes numerous bearing components, and wherein the bearing is produced from numerous bearing components in a production process, the server system comprising:
a first interface component configured to record the data relating to the numerous bearing components and the production process;
a data storage component, which is configured for storing the data; and
at least one processor component configured to:
generate a machine-readable ID for the positive identification of the bearing, wherein the machine-readable ID is assigned to the data, and wherein the machine-readable ID is disposed on the bearing,
identify the bearing usage data from the data; and
copy the bearing usage data in a client data base.

8. The server system according to claim 7, further comprising:
a second interface component configured to send the machine-readable ID to an authentication system that has an authentication data base.

9. A client system for processing the bearing usage data relating to a bearing, comprising:
a reader component, which is configured to read a machine-readable ID on the bearing;
an interface component, which is configured for sending an access query for access to a client data base, wherein the access query comprises the machine-readable ID; and
at least one processor component, which is configured to:
retrieve some or all bearing usage data from the client data base, and
process the retrieved for a bearing-specific activity, wherein the retrieved data can be used for the bearing-specific activity.

10. The client system according to claim 9, further comprising a data storage component, which is configured for storing the retrieved data and processed data in a client data base.

11. The client system according to claim 9, wherein the interface component is also configured such that the access query is sent to a server system that has the client data base, or such that the access query is sent to an authentication system that has an authentication data base for checking the authenticity of the bearing.

12. The client system according to any of the claims claim 9 further comprising:
another interface component, which is configured to record operating data relating to the bearing during the bearing-specific activity, and
the at least one processor component is also configured to process the operating data.

13. The client system according to claim 12, wherein the data storage component is also configured to store the operating data or the processed operating data in the client data base.

14. The client system according to claims 12, wherein the interface component is also configured to send the operating data and/or the processed operating data to a data base, in particular the client data base.

15. (canceled)
